(19) United States
(12) Patent Application Publication
(10) Pub. No.: US 2015/0007497 A1
(43) Pub. Date: Jan. 8, 2015

(54) PLANT POTTING APPARATUS AND METHOD

(71) Applicant: Steven P. Delp II, Eden Prairie, MN (US)

(72) Inventor: Steven P. Delp II, Eden Prairie, MN (US)

(21) Appl. No.: 13/936,670

(22) Filed: Jul. 8, 2013

(51) Int. Cl. A01G 9/12

(52) U.S. Cl. CPC A01G 9/12
USPC 47/66.7; 47/39

(57) ABSTRACT

A decorative plant stand that allows the caretaker to remove collected water from the plant without having to lift or remove the plant from the floor or the plant stand. The plant stand comprises a platform comprising a top surface, a bottom surface, and a thickness therebetween, the platform at least one opening in the top surface extending through the entire thickness; a rail assembly positioned below the bottom surface of the platform and fixedly attached to the platform, the rail assembly comprising at least one channel; and a removable tray slidably disposed within the at least one channel, wherein any plant water and other debris that leak from the pot through the opening in the top surface are collected within the removable tray for disposal. A method for draining water from the plant, which is collected in the tray, is also provided.

### BACKGROUND

This invention relates generally to a plant stand for use with large indoor plants. Large indoor plants are popular household decorative items. On their own, they weigh a significant amount but they are also often planted into heavy pots. They are thus cumbersome to move. When overwatered, often times the pot leaks water through an opening in the bottom of the pot. When such water leaks, it may stain the floor or stand upon which the potted plant rests.

Several issued patents describe ways in which water may be drained from a pot. U.S. Pat. Pub. No. 2012/0255226 describes a plant holder placed into a water catching basin that has a drainage hole on the bottom surface of the basin. A rubber drainage plug is inserted into the drainage hole to prevent water collected in the basin from leaking out of the basin and onto the floor, furniture, or other base upon which the plant rests. To remove the collected water, the plant holder and water catching basin must be lifted from the base in order for the plant caretaker to remove the drainage plug and drain the collected water. Most planters rely on placing a tray between the pot and the plant stand in order to catch water, requiring the pot to be lifted from the tray and the plant stand in order to drain the water. U.S. Pat. Nos. 3,949,524 and 4,167,080 to Mickelson each describe a planter with a detachable water collection tray releasably secured to the bottom of the planter. To remove water collected in the tray, the planter must be lifted in order to remove the water collection tray from the bottom of the planter. U.S. Pat. No. 6,182,394 to Bassler describes a plant holder with a planter tray disposed within a water container. The plant rests on top of the planter tray. The planter tray has a plurality of holes to position the tray and allow the passage of water in the water container to reach the potted plants. In order to remove water from the tray, the plant must be moved from the planter tray.

All of these prior art devices require the caretaker to lift or move the plant from the floor or stand in order to drain the water collected in the tray. Certainly for large, heavy indoor plants, this process can be cumbersome. It is desirable to have a plant stand where excess water can be removed from the pot without staining the floor or stand.

### BRIEF SUMMARY OF THE INVENTION

The present invention provides a decorative plant stand that allows the caretaker to remove collected water from the plant without having to lift or remove the plant from the floor or the plant stand. In the present invention, the water collection tray is placed below the plant stand, which allows for easier emptying of the collection tray without having to move or lift the plant from the floor or the plant stand. This also provides the benefit of creating a much healthier root system since the pot and the bottom of the plant are not immersed in water, allowing for drainage of the water away from the root system. The plant stand is desirable for indoor and outdoor home use, as well as for large indoor and outdoor planters at malls, stadiums and other venues in order to access and remove collected water.

In at least one embodiment, the plant stand comprises a platform comprising a top surface, a bottom surface, and a thickness therebetween, the platform at least one opening in the top surface extending through the entire thickness; a rail assembly positioned below the bottom surface of the platform and fixedly attached to the platform, the rail assembly comprising at least one channel; and a removable tray slidably disposed within the at least one channel, wherein any plant water and other debris that leak from the pot through the opening in the top surface are collected within the removable tray for disposal. In at least one embodiment, the rail assembly comprises a first rail with a first channel and a second rail with a second channel, the first channel and second channel being parallel to one another. In some embodiments, the platform further comprises at least three legs extending downwardly from the bottom surface, and the three legs may have casters attached to their ends. In at least one embodiment the opening of the plant stand has a diameter greater than a diameter of the at least one hole on the bottom of the pot. To drain water collected in the tray, which is in fluid communication with the opening in the platform of the plant stand, which is in fluid communication with the holes in the bottom of the pot, the removable tray is withdrawn from its initial position by pulling the tray outwardly much like a drawer. The collected water is then disposed and the tray is returned to its initial position by sliding the tray into the channel of the rail assembly.

In one embodiment, the plant stand comprises a plurality of slats that together form a platform comprising a top surface, a bottom surface, and a thickness therebetween, the platform having a perimeter and at least one circular opening in the top surface extending through the entire thickness; a rail assembly positioned below the bottom surface of the platform and fixedly attached to the platform, the rail assembly comprising two parallel rails each with a channel; and a removable tray slidably disposed within the channels of the two parallel rails, wherein any plant water and other debris that leak from the pot through the opening in the top surface are collected within the removable tray for disposal. In some embodiments, the plant stand further comprises a skirt disposed about the perimeter of the platform. In some embodiments, the at least one edge of the skirt is rotatably connected with the platform. In at least one embodiment, the at least one edge of the skirt is rotatably connected to the top surface of the platform by a hinged connection. In at least one embodiment where the platform comprises a plurality of slats, the two parallel rails of the rail assembly are perpendicular to the slats of the platform.

The figures and the detailed description which follow more particularly exemplify these and other embodiments of the invention.

### BRIEF DESCRIPTION OF THE SEVERAL VIEWS OF THE DRAWING(S)

The invention may be more completely understood in consideration of the following detailed description of various embodiments of the invention in connection with the accompanying drawings, which are as follows.

FIG. 1 shows a perspective view of one embodiment of the plant stand of the present invention.

FIG. 2 shows a cross sectional view of one embodiment of the plant stand of the present invention.

FIG. 3 shows a perspective view of one embodiment of the plant stand of the present invention.

FIG. 4 shows a perspective view of one embodiment of the plant stand of the present invention.

### DETAILED DESCRIPTION OF THE INVENTION

While the invention is amenable to various modifications and alternative forms, specifics thereof are shown by way of example in the drawings and described in detail herein. It should be understood, however, that the intention is not to limit the invention to the particular embodiments described. On the contrary, the intention is to cover all modifications, equivalents, and alternatives falling within the spirit and scope of the invention.

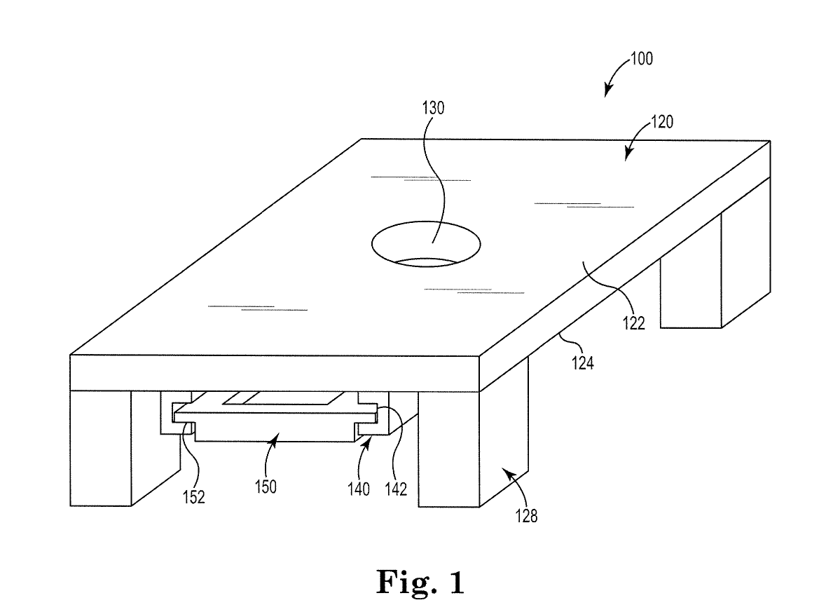

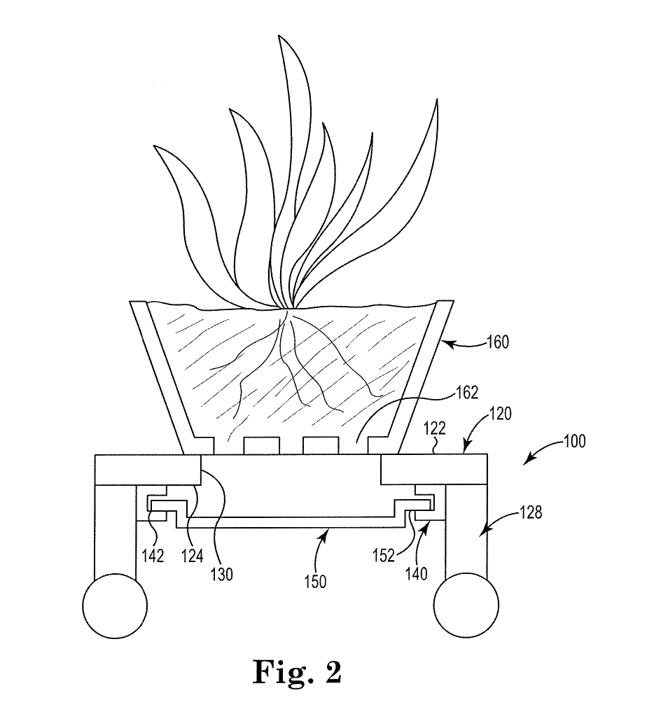

FIGS. 1-2 shows embodiments of the plant stand for a potted plant of the present invention. The plant stand 100 comprises a platform 120, a plurality of legs 128 extending downwardly from the platform 120, a rail assembly 140 having a channel 142, and a removable tray 150 slidably disposed within the channel 142 of the rail assembly. The platform 120 has a top surface 122, a bottom surface 124 and a thickness therebetween. The legs 128 extend downwardly from the bottom surface 124 of the platform. In at least one embodiment, the legs 128 have casters so that the plant stand 100 can be rolled on a floor surface. The platform 120 and the legs 128 may comprise wood, metal, ceramic or plastic material. The platform 120 has a least one opening 130 in the top surface 122 that extends through the entire thickness of the platform. In at least one embodiment, the opening 130 has an area that is greater than the area of at least one hole on the bottom of the pot for the plant. In at least one embodiment, the opening 130 is circular and has a diameter that is greater than the diameter or major dimension of the opening or hole on the bottom of the pot. In some embodiments, the opening 130 may be circular or comprise other shapes, but importantly, the opening 130 has a major dimension that is greater than the major dimension of the opening or hole on the bottom of the pot and the opening 130 has a major dimension which is less than the major dimension of the bottom of the pot such that the pot rests on the top surface 122 rather than within the opening 130. The rail assembly 140 is fixedly attached to either the legs 128 or the bottom surface 124 of the platform. The rail assembly 140 is positioned such that the removable tray 150 can be positioned below the opening and can clear the legs 128 when being slidably withdrawn in the channel 142 of the rail assembly. In at least one embodiment, as shown in at least FIG. 1, the rail assembly 140 comprises two parallel rails, each with a channel 142. In at least one embodiment, the channel 142 of the rail assembly has a depth greater than a depth of the removable tray 150 such that the entire depth of the removable tray 150 rests in the channel 142 of the rail assembly 140. In at least one embodiment, as shown at least in FIG. 1, the removable tray 150 has a lip 152 that rests in the channel 142 of the rail assembly. In any embodiment, the removable tray 150 may comprise wood, metal, ceramic or plastic material. When the potted plant is on the plant stand, the holes 162 on the bottom of the pot 160 are aligned with the opening 130, as shown in the cross section of FIG. 2. Water, soil and other debris that leak from the holes 162 of the pot 160 are disposed through the opening 130 and are collected in the removable tray 150. This prevents the water, soil and other debris from staining the floor surfaces when the plant is indoors. When the plant caretaker wants to remove the water, soil and other debris, the plant caretaker simply slidably withdraws the removable tray 150 from the channel 142 to dispose of the water and debris and then slides the tray back into the channel 142.

In some embodiments, the rail assembly 140 comprises notches in the legs 128 which form the channels 142. In other embodiments, the rail assembly 140 is fixedly attached to the bottom surface of the platform or fixedly attached to the legs. In at least one embodiment, the rail assembly 140 is similar to a rail assembly for a drawer and may comprise rollers to aid in slidably moving the tray in the channel.

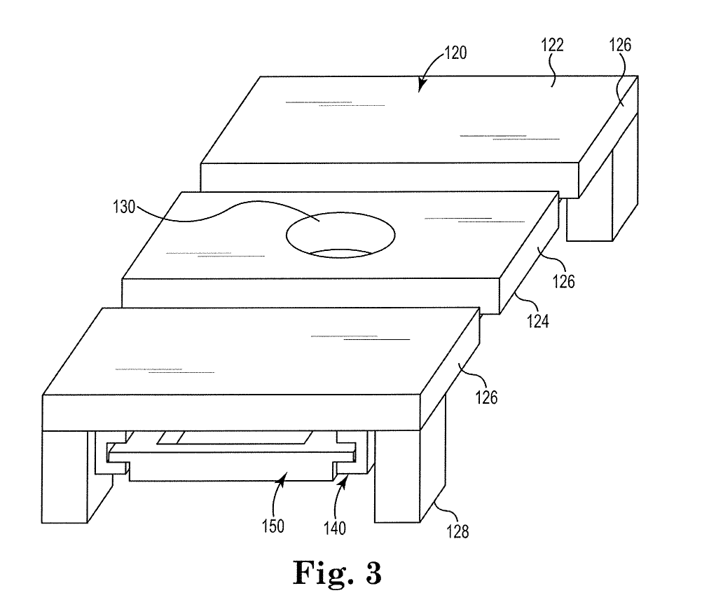

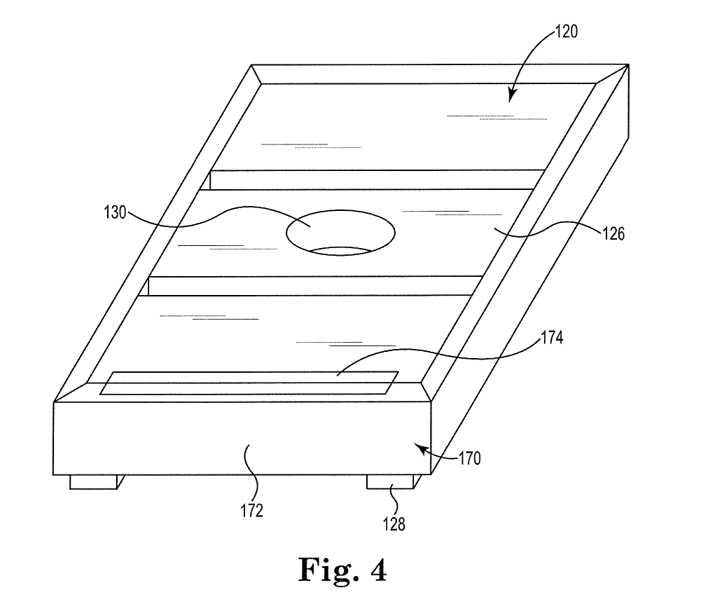

In some embodiments, the platform 120 comprises a solid piece of material. In some embodiments, the platform 120 may have a rectangular, square, diamond, triangle, or circular shape. In some embodiments, as shown in FIGS. 3-4, the platform 120 may comprise a plurality of slats 126. In at least the embodiment shown in FIG. 3, where the platform 120 comprises a plurality of slats, the rail assembly 140 is fixedly attached to the bottom surface of the platform 120 and joins all of the slats 126 together. In at least the embodiment shown in FIG. 3, the rails of the rail assembly 140 are installed perpendicular to the slats 126.

In at least one embodiment, the platform 120 comprises a plurality of surface features such as notches, grooves, and ridges on the top surface 122 of the platform that help properly position the pot on the top surface.

In the embodiments of FIGS. 1-3, the removable tray 150 is exposed, which may be undesirable. In at least one embodiment, the plant stand 100 further comprises a skirt 170 along the perimeter of the platform 120 that hides the removable tray (not shown). In some embodiments, at least one edge 172 of the skirt can be removed to expose the removable tray and allow it to be withdrawn from the plant stand in order to dispose of the collected water and debris. In some embodiments, at least one edge 172 of the skirt 170 has a hinged connection 174 with the platform 120. In at least one embodiment, only one edge of the skirt 170 is rotatably connected to the platform 120. In at least one embodiment, the edge 170 is rotatably connected by the hinged connection 174 to the top surface of the platform 120. The edge 172 can be rotated about the hinged connection 174 into an open position (not shown) and closed position (shown in FIG. 4). In the closed position, shown in FIG. 4, the rail assembly 140 and the removable tray 150 are hidden from view and the removable tray cannot be accessed. When in the open position, as shown in FIG. 6, the removable tray 150 can be accessed and withdrawn. In at least one embodiment, the skirt 170 is the same material as the material used for the platform 120. In other embodiments, the skirt 170 is a different material than the material used for the platform 120.

A method for removing collected water from a plant stand is provided. The method comprises draining water from the pot through the hole in the bottom of the pot, which is in communication with the opening in the platform of the plant stand, which is in communication with a removable tray slidably disposed within a channel of a rail assembly fixedly attached to a bottom surface of the platform, the removable tray being in an initial position; withdrawing the removable tray having collected water from the initial position; disposing of the collected water from the tray; and sliding the tray into the channel of the rail assembly until it reaches the initial position. In embodiments where the platform has a skirt disposed about a perimeter of the platform and at least one edge of the skirt is rotatably connected to the platform, the method further comprises rotating the at least one edge of the skirt upwardly into an open position before withdrawing the removable tray from the initial position; and rotating the at least one edge of the skirt downwardly into a closed position after the tray has been returned to the initial position.

The present invention should not be considered limited to the particular examples described above, but rather should be understood to cover all aspects of the invention. Various modifications, equivalent processes, as well as numerous structures to which the present invention may be applicable will be readily apparent to those of skill in the art to which the present invention is directed upon review of the present specification.

What is claimed is:

1. A plant stand for a plant in a pot having at least one hole on the bottom of the pot, comprising:
a platform comprising a top surface, a bottom surface, and a thickness therebetween, the platform at least one opening in the top surface extending through the entire thickness;
a rail assembly positioned below the bottom surface of the platform and fixedly attached to the platform, the rail assembly comprising at least one channel; and
a removable tray slidably disposed within the at least one channel, wherein any plant water and other debris that leak from the pot through the opening in the top surface are collected within the removable tray for disposal.

2. The plant stand of claim 1, wherein the rail assembly comprises a first rail with a first channel and a second rail with a second channel, the first channel and second channel being parallel to one another.

3. The plant stand of claim 1, the platform further comprising at least three legs extending downwardly from the bottom surface.

4. The plant stand of claim 3 further comprising casters attached to the end of each of the at least three legs.

5. The plant stand of claim 1, wherein the depth of the removable tray is less than the thickness of the platform.

6. The plant stand of claim 1, the platform comprising a plurality of slats.

7. The plant stand of claim 6, wherein the rail assembly is fixedly attached to the bottom surface of the platform to join the plurality of slats together.

8. The plant stand of claim 7, wherein the rail assembly comprises a first rail and a second rail, wherein the first rail and second rail are parallel to one another and the first rail and the second rail are perpendicular to the slats.

9. The plant stand of claim 1, wherein the opening has a diameter greater than a diameter of the at least one hole on the bottom of the pot.

10. The plant stand of claim 1, wherein the platform has a perimeter, and a skirt is disposed about the perimeter of the platform.

11. The plant stand of claim 10, wherein at least one edge of the skirt is rotatably connected with the platform.

12. The plant stand of claim 11, wherein the at least one edge of the skirt is connected to the top surface of the platform by a hinged connection.

13. A plant stand comprising:
a plurality of slats that together form a platform comprising a top surface, a bottom surface, and a thickness therebetween, the platform having a perimeter and at least one circular opening in the top surface extending through the entire thickness;
a rail assembly positioned below the bottom surface of the platform and fixedly attached to the platform, the rail assembly comprising two parallel rails each with a channel; and
a removable tray slidably disposed within the channels of the two parallel rails, wherein any plant water and other debris that leak from the pot through the opening in the top surface are collected within the removable tray for disposal.

14. The plant stand of claim 13, further comprising a skirt disposed about the perimeter of the platform.

15. The plant stand of claim 14, wherein at least one edge of the skirt is rotatably connected with the platform.

16. The plant stand of claim 15, wherein the at least one edge of the skirt is connected to the top surface of the platform by a hinged connection.

17. The plant stand of claim 13, wherein the opening has a diameter greater than a diameter of the at least one hole on the bottom of the pot.

18. The plant stand of claim 13, wherein the two parallel rails of the rail assembly are perpendicular to the slats of the platform.

19. A method of draining water from a large plant disposed within a pot having a hole in the bottom of the pot, the pot resting on a platform of a plant stand, the method comprising:
draining water from the pot through the hole in the bottom of the pot, which is in communication with an opening in the platform of the plant stand, which is in communication with a removable tray slidably disposed within a channel of a rail assembly fixedly attached to a bottom surface of the platform, the removable tray being in an initial position;
withdrawing the removable tray having collected water from the initial position;
disposing of the collected water from the tray; and
sliding the tray into the channel of the rail assembly until it reaches the initial position.

20. The method of claim 19, wherein the platform has a skirt disposed about a perimeter of the platform and at least one edge of the skirt is rotatably connected to the platform, the method further comprising:
rotating the at least one edge of the skirt upwardly into an open position before withdrawing the removable tray from the initial position; and
rotating the at least one edge of the skirt downwardly into a closed position after the tray has been returned to the initial position.
